(19) United States
(12) Patent Application Publication
(10) Pub. No.: US 2001/0019449 A1
(43) Pub. Date: Sep. 6, 2001

(54) Low-noise bidirectional optical amplifier

(76) Inventor: Peter Krummrich, Munchen (DE)

Correspondence Address: SCHIFF HARDIN & WAITE, 6600 SEARS TOWER, 233 S WACKER DR, CHICAGO, IL, 60606-6473, US

(21) Appl. No.: 09/775,269

(22) Filed: Feb. 1, 2001

(30) Foreign Application Priority Data
Feb. 2, 2000 (DE) 100 04 435.2

(51) Int. Cl. H01S 3/00

(52) U.S. Cl. 359/341.2

(57) ABSTRACT

A low-noise bidirectional optical amplifier is arranged so that the bidirectional transmission fiber is divided into two unidirectional branches by two circulators. Each of the branches is equipped with at least two amplifiers with at least one optical filter element disposed therebetween. Preferably, the first amplifier of each unidirectional branch is an active fiber which is pumped through a wavelength-division multiplex coupler that is arranged to follow the active fiber.

### BACKGROUND OF THE INVENTION

The present invention is directed to a low-noise optical amplifier for bidirectional transmission links in an optical wavelength-division multiplex system (WDM).

In the transmission of wavelength-division multiplex signals in a single optical fiber, the fiber can be used in a bidirectional or a unidirectional direction for the transmission of the signals. Compared to the transmission in unidirectional direction, bidirectional transmission offers a number of advantages. These advantages include that the transmission link requires only one fiber for the forward and return direction and that non-linear effects can also be reduced given a skillful arrangement of the channels or bands.

Due to their excellent attenuation properties, optical fibers are suited for the transmission of signals over long distances. Despite these good attenuation properties, signals need a regeneration with an optical amplifier after a certain distance. Optical fiber systems that are currently employed work with a typical attenuation of the line section of 20 dB through 30 dB. An optical amplifier that can offer a gain of at least 30 dB is, therefore, required.

Traditional optical amplifiers can process bidirectionally transmitted channels in a single optical fiber only up to a gain of approximately 20 dB. Given higher gains, multiple reflections lead to uncorrectable distortions of the signals.

An optical amplification of the signals of at least 30 dB, however, can be achieved by dividing the fiber of a bidirectional line section into two unidirectional branches. The amplification of the signals then respectively occurs in the unidirectional branches. After the amplification of the signals, the unidirectional branches are reunited to form a fiber with a bidirectional transmission.

U.S. Pat. No. 5,280,383, whose disclosure is incorporated herein by reference thereto, discloses an amplifier arrangement for a fiber wherein an optical filter element and an isolator are arranged between two amplifiers. The first amplifier has the job of pre-amplifying the incoming signal, whereas the second amplifier assumes the final amplification. One disadvantage of this arrangement is the weakening of the already-weak signal in front of the first amplifier stage, since the signal spectrum to be amplified is attenuated due to the insertion attenuation of the optical filter element and the noise behavior of the overall arrangement is, thus, deteriorated.

### SUMMARY OF THE INVENTION

An object of the present invention is to make an arrangement available that allows a high-power, low-noise amplification of bidirectional optical signals.

This object is achieved by a bidirectional optical amplifier for an optical wavelength-division multiplex transmission system (WDM) composed of a bidirectional line section and two circulators or beam dividers that will divide the bidirectional line section into two unidirectional branches. Each of the unidirectional branches has a first optical amplifier and a second optical amplifier with an optical filter arranged between the first amplifier and the second amplifier.

Expediently, the bidirectional line section is an optical fiber. What is thereby understood as a “bidirectional line section” is an optical fiber that is to be traversed by signals in a forward and a return direction, whereas what is understood as a “unidirectional branch” is an optical fiber that is completely traversed by signals in only one direction, which may be either a forward direction or a return direction. Circulators that can suppress multiple reflections are suitable as a further expedient embodiment.

Over and above this, the above-described arrangement of the optical elements in the unidirectional branches has the advantage that they prevent ring reflections. The optical band-pass filters suppress ring reflections because they are arranged so that the signal spectrum that can pass the optical filter element does not overlap in the two filter elements. Moreover, the arrangement has the advantage that the band-pass filter is arranged after the first amplifier in a unidirectional branch, so that a signal that is already weak is first amplified by the first amplifier before it is weakened again by the insertion attenuation of the band-pass filter.

In a further advantageous exemplary embodiment, the amplifier is provided with at least one isolator which is arranged in the unidirectional branch. The isolator is advantageous for the suppression of spontaneous emission (ASE). An especially advantageous arrangement is to be seen wherein the isolator is arranged directly in front of the second amplifier. The isolator can, thus, keep the ASE generated by a second or following amplifier away from the first optical amplifier more effectively.

An especially advantageous embodiment of a first amplifier for the unidirectional branch comprises at least one active fiber section, at least one pump source and at least one wavelength-division multiplex coupler, wherein the wavelength-division multiplex coupler (WDM coupler) is arranged behind the active fiber section. A laser diode having an output signal or wavelength of 980 nm is usually employed as the pump source. However, other laser diodes can also be employed. What is advantageous about this development is the lack of optical elements between the circulator and the active fiber producing the amplification. The lack of optical elements in this part of the unidirectional branch has the advantage that an incoming, weak optical signal is not weakened further by insertion attenuation of an optical element. The sole optical element that effects the weakening of the incoming, weak signal is the circulator. As a result of this arrangement, the first amplifier stage of the unidirectional branch is especially a low-noise stage.

An erbium-doped fiber section is preferably employed as the active fiber section that is pumped by the pump source. The erbium-doped fiber section is especially effective because it produces high amplification rates and high output power and, over and above this, works nearly noise-free. However, other laser-active, ion-doped fiber sections can, likewise, be employed as pumpable fiber sections.

Other advantages and features of the invention will be readily apparent from the following description of the preferred embodiments, the drawings and claims.

### BRIEF DESCRIPTION OF THE DRAWINGS

FIG. 1 is a block circuit diagram of an exemplary embodiment of an inventive bidirectional optical amplifier with a band-pass filter;

FIG. 2 is a block circuit diagram of a second embodiment of an inventive bidirectional optical amplifier with a comb filter;

FIG. 3 is a block circuit diagram of a portion of an inventive amplifier;

FIG. 4 is a block circuit diagram of a portion of another embodiment of the inventive amplifier; and

FIG. 5 is a block circuit diagram of another exemplary embodiment of a bidirectional amplifier with the first portion being shown in FIG. 5A and the second portion being shown in FIG. 5B.

### DESCRIPTION OF THE PREFERRED EMBODIMENTS

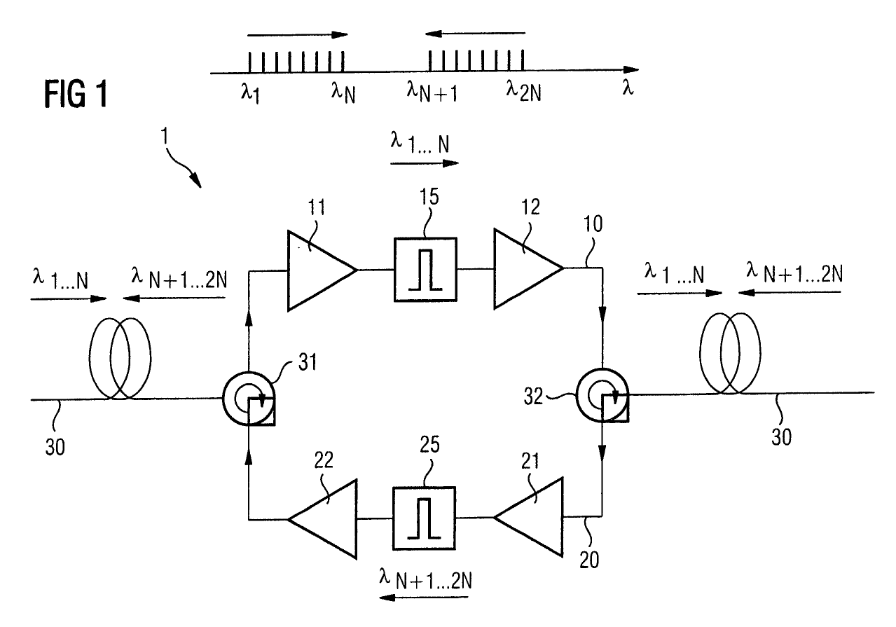

FIG. 1 shows a block circuit diagram of an exemplary embodiment of an inventive bidirectional optical amplifier 1. Channels or, respectively, bands in the forward direction (λ1-λ N) and in the return direction (λN+1 - λ2N) are transmitted in the bidirectional line section 30. The bidirectional line section is divided into two unidirectional branches 10 and 20 by a circulator 31 at one end and by a circulator 32 at the other end where the split-off or divided portion is then reunited. A first optical amplifier 11 and a second optical amplifier 12 with a band-pass filter 15 therebetween are arranged in the unidirectional branch 10. The arrangement of the optical amplifier 21, the band-pass filter 25 and the second optical amplifier 22 are in the unidirectional branch 20.

FIG. 1 shows a bidirectional transmission of wavelength-division multiplex signals with neighboring wavelength bands that do not overlap one another. The circulators 31 and 32 conduct the signal spectrum of λ1 - λ2N of the bidirectional line section 30 into the unidirectional branches 10 and 20.

The circulators 31 and 32 not only conduct the entire incoming signal spectrum into the unidirectional branches 10 and 20, but also simultaneously suppress the multiple reflections, since they act as isolators at the inputs and outputs of the amplifiers. The incoming bidirectional wavelength-division multiplex signal is conducted onto the unidirectional branch 10 by the circulator 31. The wavelength-division multiplex signal (λ1 - N) enters into the first amplifier 11 and is amplified therein and then passes through the optical band-pass filter 15, whereby the optical band-pass filter only allows those spectral parts to pass that are to be amplified by the second optical amplifier 12. In FIG. 1, the optical band-pass filter 15 should only allow the spectral parts of the forward direction of the bidirectional signal λ1 - λN to pass, whereas the spectral parts of the return direction of the bidirectional signal λN+1 - λ2N cannot pass. The circulator 32 reinstates the amplified signal λ1 - λN into the bidirectional line section 30. The analogous case applies to the spectral parts of the return direction of the bidirectional signal λN+1 - λ2N that is amplified by the unidirectional branch 20 of the bidirectional optical amplifier 1.

The optical band-pass filters 15 and 25 also have the job of suppressing arising ring reflections. The band-pass filter 15 of the unidirectional branch 10 preferably comprises no overlap with the pass band of the band-pass filter 25 of the unidirectional branch 20. If there were an overlap of the pass band of the two band-pass filters, it would be conceivable, for example, that signals of the wavelength λ1 that are located within the overlap region of the two band-pass filters 15 and 25 could pass through the circular arrangement of the bidirectional optical amplifier without loss.

The first amplifiers 11 and 21 of the unidirectional branches 10 and 20 have the job of only slightly amplifying the respective signal. Due to the arrangement of the first amplifiers 11 and 21 in front of the optical band-pass filters 15 and 25, spectral lines that are actually not to be amplified also proceed into the amplifiers 11 and 21, as a result whereof the first amplifiers 11 and 21 would reach their saturation limit faster. Only a slight amplification therefore occurs at the first amplifier, usually in the range of 10 dB. The signal is especially preferably amplified in the linear region of the amplifier by the first optical amplifiers 11 and 21. A slight gain at the first optical amplifiers 1 1 and 21 had the additional advantage that only a slight spontaneous emission (ASE) is produced as a result thereof, which, in turn, does not lead to an upward transgression of the saturation limit in the first optical amplifier 11 or 21.

The arrangement of the optical filter elements 15 and 25, after first optical amplifiers 11 and 21 and before the second optical amplifiers 12 and 22 has the advantage compared to the previous arrangement of a bidirectional optical amplifier 1 that the insertion attenuation of the band-pass filters 15 and 25 does not deteriorate the respective incoming signal, since the signal was previously amplified. This advantage is expressed therein that the inventive bidirectional optical amplifier 1 amplifies the wavelength-division multiplex signal with low-noise.

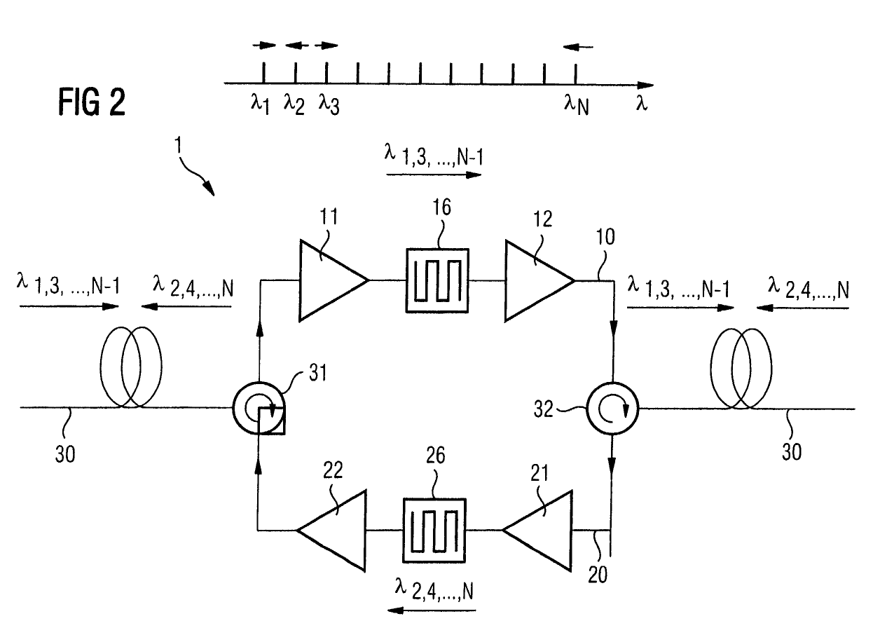

Analogous to FIG. 1, comb filters 16 and 26 are built in between the amplifier stages in the arrangement of FIG. 2 by way of example. The amplification of the optical wavelength-division signal occurs in the same was as in FIG. 1. However, the amplification of an alternating wavelength-division multiplex signal becomes possible for the bidirectional amplifier 1 due to the incorporation of comb filters 16 and 26. The circulators 31 and 32 and the comb filters 16 and 26 divide the wavelength-division multiplex signal of the bidirectional line section 30 into a part in a forward direction (λ1, λ3, . . . , λ2N−1) and a part in a return direction (λ2, λ4, . . . , λ2N).

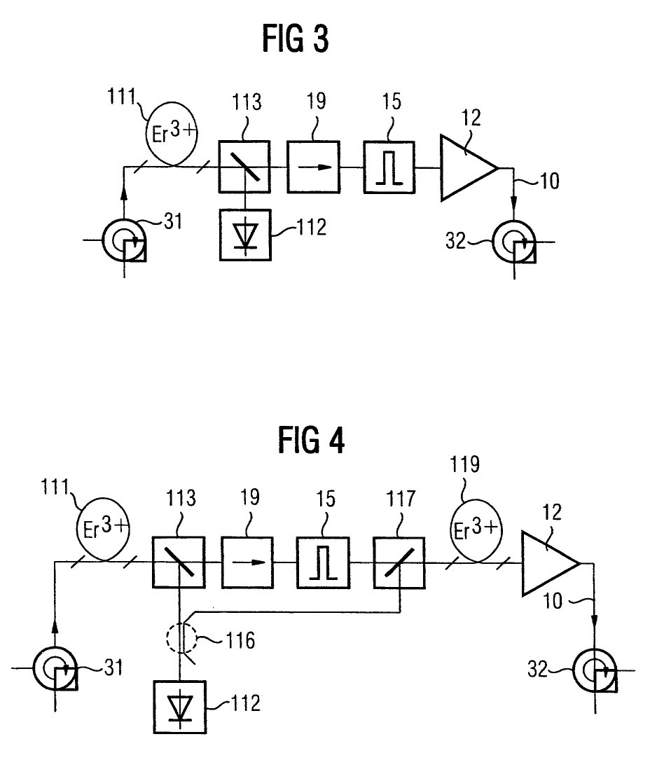

FIG. 3 shows a unidirectional branch 10 of a bidirectional optical amplifier 1 by way of example. An erbium-doped fiber section 111, a wavelength-division multiplex coupler or WDM coupler 113 that is connected to a pump source 112, an isolator 19, a band-pass filter 15 and a second optical amplifier 12 are arranged between the two circulators 31 and 32. The wavelength-division multiplex signal incoming through the circulator 31 is directly conducted into the erbium-doped fiber section 111, which is a counterdirectionally pumped by the pump source 112 via the wavelength-division multiplex coupler 113. The amplified wavelength-division multiplex signal then passes an isolator 19 and a band-pass filter 15 that only filters the desired spectral lines from the incoming wavelength-division multiplex signal before the signal experiences the desired amplification with the second amplifier 12 and is resupplied into the bidirectional section 30 by the circulator 32.

The first optical amplifier 11 arranged in this way with the erbium-doped fiber section 111 pumped from behind has the advantage that no optical element is present preceding the active fiber section 111 and, thus, the incoming wavelength-division multiplex signal experiences no further attenuation by an optical element preceding the amplification, except for the insertion attenuation by the circulator 31. The optical elements that would deteriorate the noise behavior of the first amplifier stage due to their insertion attenuation, for example the wavelength-division multiplex coupler 113 and the band-pass filter 15, are arranged behind or following the active fiber section 111 and only attenuate the wavelength-division multiplex signal after the amplification. This attenuation, however, has no negative effect on the amplified signal, since the insertion attenuation is lower than the previously occurring amplification by the first optical amplifier 11. Thus, information is not lost.

The erbium-doped fiber section 111 or, respectively, the pump laser 112 is selected so that the amplifier stage amplifies the incoming wavelength-division multiplex (WDM) signal by only about 12 dB. Due to this low gain, the saturation threshold of the amplifier 11 is not reached. Since the band-pass filter 15 is arranged following the active fiber section 111, channels that are not to be amplified also proceed into the active fiber section 111. Due to the slight gain, the sum of all levels of the channels, i.e., also of those that are actually not to be amplified, lies under the saturation limit of the active fiber section 111. The amplified signal is therefore not distorted.

The isolator 19 has the job of keeping the spontaneous emission (ASE) that is produced by the following amplifier stage, specifically the amplifier 12, and that propagates in the direction opposite the signals to be amplified away from the first amplifier 11. A penetration of this ASE into the active fiber section 111 could lead to the saturation of the active fiber section 111 and negatively influence the noise behavior of the overall amplifier.

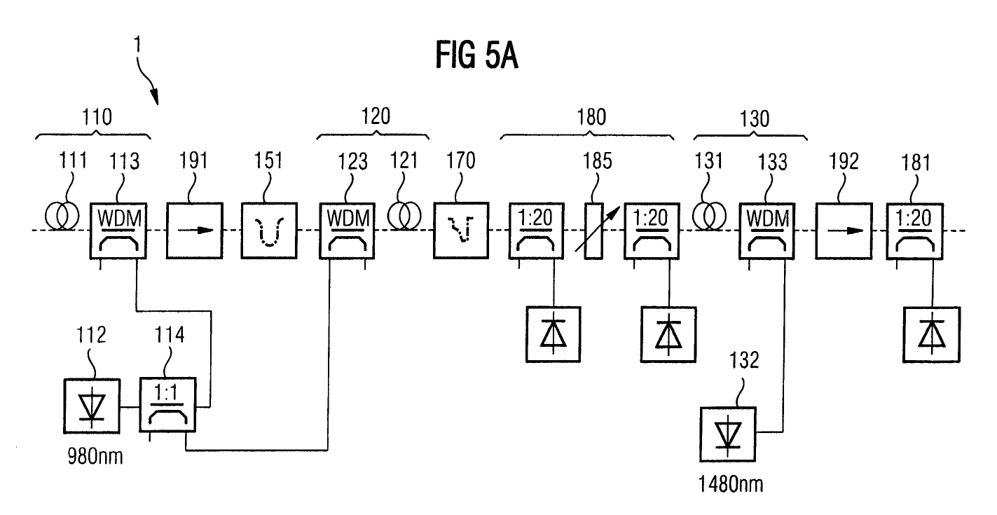

FIG. 4 shows a structure analogous to FIG. 3. However, the pump source 112 active fiber sections 111 and 119 can be pumped with one pump source 112 via a power divider 116 and that the required low power of the first fiber section 111 can be made available at the same time.

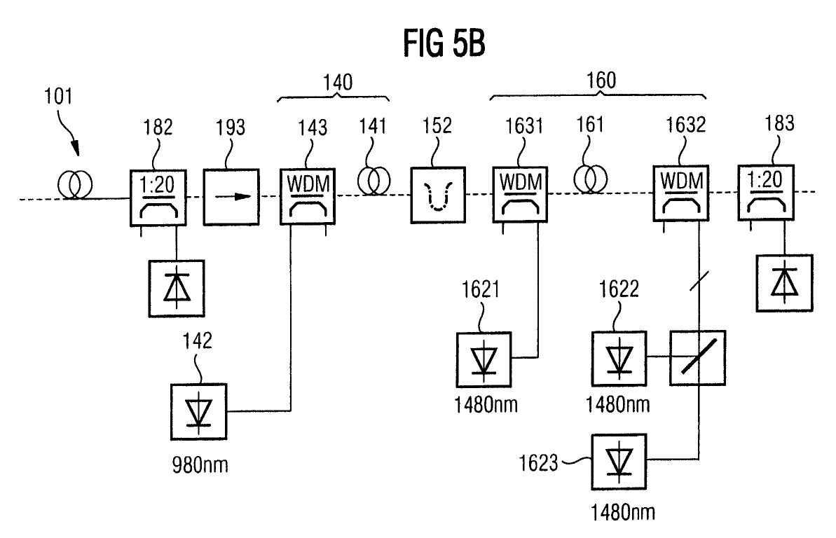

FIG. 5 shows an especially advantageous embodiment of the inventive amplifier, with FIG. 5A having the first portion and FIG. 5B having the second portion. FIG. 5 shows an arrangement of optical elements of a unidirectional branch 10 or 20 between two circulators 31 and 32 of a bidirectional line section 30. The arrangement contains five amplifiers 110, 120, 130, 140 and 160 (FIG. 5B). Each of these amplifiers contains an erbium-doped fiber section which is numbered 111, 121, 131, 141 or 161. One WDM coupler 113, 123, 133 or 143 is provided at the four amplifiers 110-140. The amplifier 160 includes two WDM couplers 1631 and 1632. The two amplifiers 110 and 120 are supplied by a pump source 112 with a wavelength in the 980 nm range via a power divider 114. The amplifier 130 is supplied via a pump laser 132 with a light of a wavelength in the 1480 nm range, whereas the amplifier 140 is pumped by a pump laser 140 with a wavelength in the 980 nm range. The amplifier 160, in contrast, is pumped via three lasers 1621, 1622 and 1623, which produce a wavelength in the 1480 nm range, whereas the pump source 1621 is arranged in front of the optically active fiber section 161 on the one occasion and the lasers 1622 and 1623 are arranged following the optically active fiber section 161. The lasers 1622 and 1623 are preferably operated in multiplex.

An isolator 191 and a band-pass filter 151 (FIG. 5A) are applied between the first amplifier 110 and the second amplifier 120. The second amplifier 120 is followed by a gain-flattening filter 170 that is, in turn, followed by a tab coupler arrangement 180 that contains a variable optical attenuation element 185. A dispersion-compensating fiber section 101 (FIG. 5B) that is framed by two isolators 192 (FIG. 5A) and 193 (FIG. 5B) and various coupling elements 181 and 182 is attached after the amplifier 130. The amplifier arrangement than again comprises an amplifier 140 that is followed by a band-pass filter 152. Another amplifier stage 160 that is terminated by the coupling element 183 is provided after the band-pass filter 152.

The function of the inventive input stage has already been described with regard to FIG. 4. The gain-flattening filter 170 (FIG. 5A) has the job of leveling the gain spectrum acquired by the first two amplifying stages 110 and 120. As a result of the two tab couplers 180, 5% of the spectrum height is coupled out of the signal path in order to make the signal spectrum visible via a monitor. The variable optical attenuation element 185 serves for the compensation of dynamic gain tilt.

After renewed amplification in the amplifier 130 and measurement of the coupling element 181, a dispersion-compensating fiber section 101 follows. An add-drop multiplexer is preferably employed as a dispersion-compensating fiber section 101, and this compensates the dispersion and the individual channels being capable of being supplied into the fiber and coupled out of the fiber with this multiplexer. The use of a dispersion-compensating fiber section preferably occurs quite specifically at locations at which the inventive amplifier is used, since the optical signal is already adequately amplified here, and non-linear effects which could occur due to full amplification have not yet arisen.

The signal spectrum is fixed to the desired bandwidth with the a further amplifier stage 140 and a further band-pass filter 152 before it is fully amplified in the last amplifier stage 160, whose fiber section 161 is counterdirectionally pumped from the front and the back with a polarization-multiplexed wavelength 1480 from the lasers 1621, 1622 and 1623.

The inventive, low-noise bidirectional optical amplifier makes an arrangement available that allows a high-power, low-noise amplification of bidirectional optical signals.

The present invention is directed to a low-noise bidirectional optical amplifier that is arranged in a bidirectional transmission fiber so that the bidirectional fiber is divided into two unidirectional branches with two circulators. The unidirectional branches are equipped with at least two amplifiers between which, preferably, at least one optical filter element and, preferably, at least one isolator are arranged. Moreover, the active fiber of the first amplifier of the unidirectional branches is preferably pumped by a wavelength-division multiplex coupler that is arranged following the active fiber.

Although various minor modifications may be suggested by those versed in the art, it should be understood that I wish to embody within the scope of the patent granted hereon all such modifications as reasonably and properly come within the scope of my contribution to the art.

I claim:

1. A bidirectional optical amplifier for an optical wavelength-division multiplex transmission system comprising a bidirectional line section, two circulators for dividing the bidirectional line section into two unidirectional branches, each unidirectional branch having a first optical amplifier and a second optical amplifier with an optical filter being arranged between the first optical amplifier and the second optical amplifier.

2. A bidirectional optical amplifier according to claim 1, which includes at least one isolator being arranged in each of the unidirectional branches.

3. A bidirectional optical amplifier according to claim 2, wherein the first optical amplifier for the unidirectional branch comprises at least one active fiber section, at least one pumping source and at least one wavelength-division multiplex coupler, the wavelength-division multiplex coupler being arranged after the active fiber section.

4. A bidirectional optical amplifier according to claim 3, wherein the active fiber section is a erbium-doped fiber section.

5. A bidirectional optical amplifier according to claim 4, wherein the pump source is connected to more than one wavelength-division multiplex coupler.

6. A bidirectional optical amplifier according to claim 4, wherein the first optical amplifier is fashioned so that adjacent signals can be amplified in a linear, unsaturated range.

7. A bidirectional optical amplifier according to claim 4, wherein the filter is selected from a band-pass filter, a comb filter and a gain-flattening filter.

8. A bidirectional optical amplifier according to claim 4, wherein each of the unidirectional branches has a plurality of optical filters.

9. A bidirectional optical amplifier according to claim 3, wherein the pump source is connected to more than one wavelength-division multiplex coupler.

10. A bidirectional optical amplifier according to claim 3, wherein the first optical amplifier is fashioned so that the adjacent signal can be amplified in a linear, unsaturated range.

11. A bidirectional optical amplifier according to claim 3, wherein the filter is selected from a band-pass filter, a comb filter and a gain-flattening filter.

12. A bidirectional optical amplifier according to claim 3, wherein the unidirectional branch comprises a plurality of optical filters.

13. A bidirectional optical amplifier according to claim 2, wherein the first optical amplifier is fashioned so that the adjacent signals can be amplified in a linear, unsaturated range.

14. A bidirectional optical amplifier according to claim 2, wherein the filter is selected from a band-pass filter, a comb filter and a gain-flattening filter.

15. A bidirectional optical amplifier according to claim 1, wherein each unidirectional branch has a plurality of optical filters.

16. A bidirectional optical amplifier according to claim 1, wherein the first optical amplifier for each unidirectional branch comprises at least one active fiber section, at least one pump source and at least one wavelength-division multiplex coupler and the wavelength-division multiplex coupler is arranged after the active fiber section.

17. A bidirectional optical amplifier according to claim 16, wherein the active fiber section is an erbium-doped fiber section.

18. A bidirectional optical amplifier according to claim 16, wherein the pump source is connected to more than one wavelength-division multiplex coupler.

19. A bidirectional optical amplifier according to claim 1, wherein the first optical amplifier is fashioned so that the adjacent signals can be amplified in a linear, unsaturated range.

20. A bidirectional optical amplifier according to claim 1, wherein the filter is selected from a group consisting of a band-pass filter, a comb filter and a gain-flattening filter.
